(19) United States
(12) Patent Application Publication
(10) Pub. No.: US 2003/0147312 A1
(43) Pub. Date: Aug. 7, 2003

(54) Portable timepiece

(76) Inventors: Haruki Hiranuma, Chiba-shi (JP); Nobukazu Oomori, Chiba-shi (JP); Hisamitsu Yoshikawa, Chiba-shi (JP)

Correspondence Address: ADAMS & WILKS, 31st Floor, 50 Broadway, New York, NY, 10004, US

(21) Appl. No.: 10/349,881

(22) Filed: Jan. 23, 2003

(30) Foreign Application Priority Data
Jan. 30, 2002 (JP) 2002-021975

(51) Int. Cl. G04B 29/00; G04B 37/00

(52) U.S. Cl. 368/319; 368/308

(57) ABSTRACT

To enable instantaneously making switchover of an operating part between a locked state and an unlocked state. An operating button is arranged to be capable of being rotatingly operated between a locked position and an unlocked position, and a stopper member is provided integral with the operating button. When the operating button is in the locked position, projections engage with grooves to restrict movement of the operating button toward a casing. When the operating button is rotated degrees to come to the unlocked position, the projections engage with grooves, which are greater in depth than the grooves, whereby the operating button can be operatively pushed toward the casing.

### BACKGROUND OF THE INVENTION

1. Field of the Invention

The present invention relates to a locking structure for an operating part in a portable timepiece such as wrist timepiece or the like.

2. Description of the Prior Art

Conventionally, portable timepieces with an operating part, such as wrist timepieces or the like, are provided with an operating part locking structure, by which an operating part is locked in a predetermined position so that it is not inadvertently operated.

FIG. 8 is a cross sectional view showing an operating part locking structure in a portable timepiece according to the prior art. In addition, FIG. 8 shows both a locked state and an unlocked state of an operating button 1201.

In FIG. 8, the operating part locking structure comprises the operating button 1201, a rotating member 1202 having threads 1206 therein, a coil spring 1203 for biasing the operating button 1201 in a direction, in which the button is caused to protrude from a casing 1200 of a timepiece body, and a cylindrical member 1207 provided at an outside thereof with threads 1208, which are threaded into the threads 1206.

Provided on an end 1204 of the operating button 1201 toward the casing 1200 is a latch member 1205, which prevents the operating button 1201 from falling off the cylindrical member 1207 due to the bias of the coil spring 1203.

A switch 1209 is arranged in the vicinity of the end 1204 of the operating button 1201 within the casing 1200.

In addition, the reference numeral 1202a denotes a position, in which the rotating member 1202 is put in a locked state, and 1202b a position, in which the rotating member 1202 is put in an unlocked state.

An explanation will be given to a motion of the operating part locking structure constructed in the above manner.

First, when in the locked state, the rotating member 1202 is in the position 1202a. In this state, the operating button 1201 abuts against the rotating member 1202a, so that the operating button 1201 cannot be operatively pushed toward the casing 1200.

Beginning with this state, the rotating member 1202a is operatively rotated plural times, and then the rotating member 1202a advances toward the casing 1200 while being threaded onto the cylindrical member 1207.

When the rotating member 1202 comes to an unlocked position (position of the rotating member 1202b) to abut against the casing 1200, a gap is produced between the operating button 1201 and the rotating member 1202b, so that the operating button 1201 can be operatively pushed toward the casing 1200 against the bias of the coil spring 1203.

The switch 1209 is operated in the unlocked state by operatively pushing the operating button 1201 toward the casing 1200. Thereby, the function corresponding to the switch 1209 can be implemented.

When the unlocked state should shift to the locked state, the rotating member 1202 is rotated plural times in a reverse direction to that in the above rotation whereby the position (position of the rotating member 1202a) in the locked state comes out.

In the above manner, switchover between the locked state, in which the operating button 1201 is locked, and the unlocked state, in which the operating button 1201 is released from the locked state, is made possible.

The above conventional portable timepieces have involved problems that the operation is troublesome due to the necessity of rotating the rotating member 1202 plural times, and switchover between the locked state and the unlocked state cannot be instantaneously done.

Also, there has been involved a problem that a user is uncertain as to the locked state and the unlocked state of the operating button 1201 and it is not understandable whether the operating button 1201 is put in the locked state or the unlocked state.

A task of the invention is to make it possible to instantaneously make switchover between a locked state and an unlocked state of an operating part.

Also, a task of the invention is to make it easy to recognize whether an operating part is put in a locked state or an unlocked state.

### SUMMARY OF THE INVENTION

The invention provides a portable timepiece including a timepiece body with a clocking part received in a casing, a part being operated and received in the casing, and an operating part exposed outside the casing and for operating the part being operated, the portable timepiece comprising a cylindrical member provided integrally on the casing and having a first groove or grooves having a predetermined depth and a second groove or grooves having a depth larger than the first groove or grooves, which groove or grooves are formed in an axial direction of the cylindrical member; an operating part arranged to be able to be rotatingly operated between a locked position and an unlocked position and to operatively push the cylindrical member in the unlocked position toward the casing; and a stopper member provided integrally on the operating part and having a projection or projections; and wherein the projection or projections of the elastic member when being in the locked position engage with the first groove or grooves to prevent the pushing operation of the operating part and when being in the unlocked position engage with the second groove or grooves to permit the pushing operation of the operating part. The projection or projections of the stopper member engage with the first groove or grooves of the cylindrical member, when the operating part is in the locked position, to prevent the pushing operation of the operating part and engage with the second groove or grooves of the cylindrical member, when the operating part is in the unlocked position, to permit the pushing operation of the operating part.

Here, the stopper member may be formed from an annular-shaped member and the projection or projections may be formed to protrude inwardly of the annular-shaped member.

Also, the annular-shaped member may be elastic.

Also, the first groove or grooves and the second groove or grooves, respectively, may be provided in pair in positions facing each other diametrically of the cylindrical member, and the projection or projections may be provided in pair in positions facing each other diametrically of the annular-shaped member.

Also, the operating part may be provided with identification marks, which are indicative of a locked state and an unlocked state.

Also, the part being operated may be a switch.

### BRIEF DESCRIPTION OF THE SEVERAL VIEWS OF THE DRAWINGS

A preferred form of the present invention is illustrated in the accompanying drawings in which:

FIGS. 1 are views showing an operating part locking structure in a portable timepiece according to an embodiment of the invention;

FIGS. 2 are views showing an operating part locking structure in a portable timepiece according to an embodiment of the invention;

FIG. 3 is a perspective view showing a cylindrical member used in the embodiment of the invention;

FIGS. 4 are views showing a stopper member used in the embodiment of the invention;

FIGS. 5 are exploded, perspective views showing portions of an operating part locking structure according to an embodiment of the invention;

FIGS. 6 are exploded, perspective views showing portions of an operating part locking structure according to an embodiment of the invention;

FIGS. 7 are partial, perspective views showing an operating part locking structure according to an embodiment of the invention; and

FIG. 8 is a view showing an operating part locking structure in a portable timepiece according to the prior art.

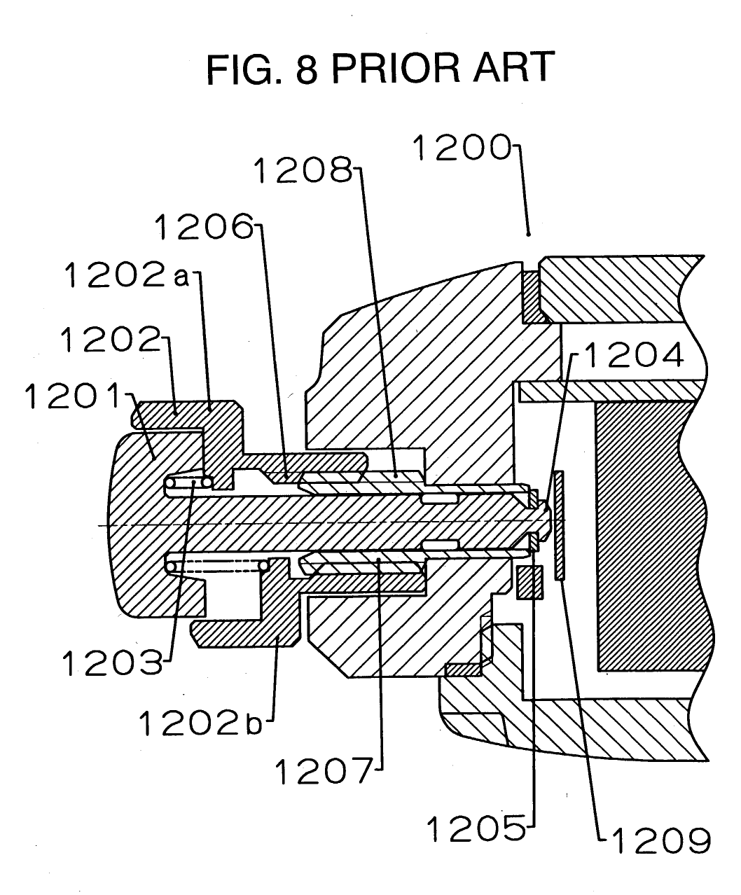

### DETAILED DESCRIPTION OF THE PREFERRED EMBODIMENTS

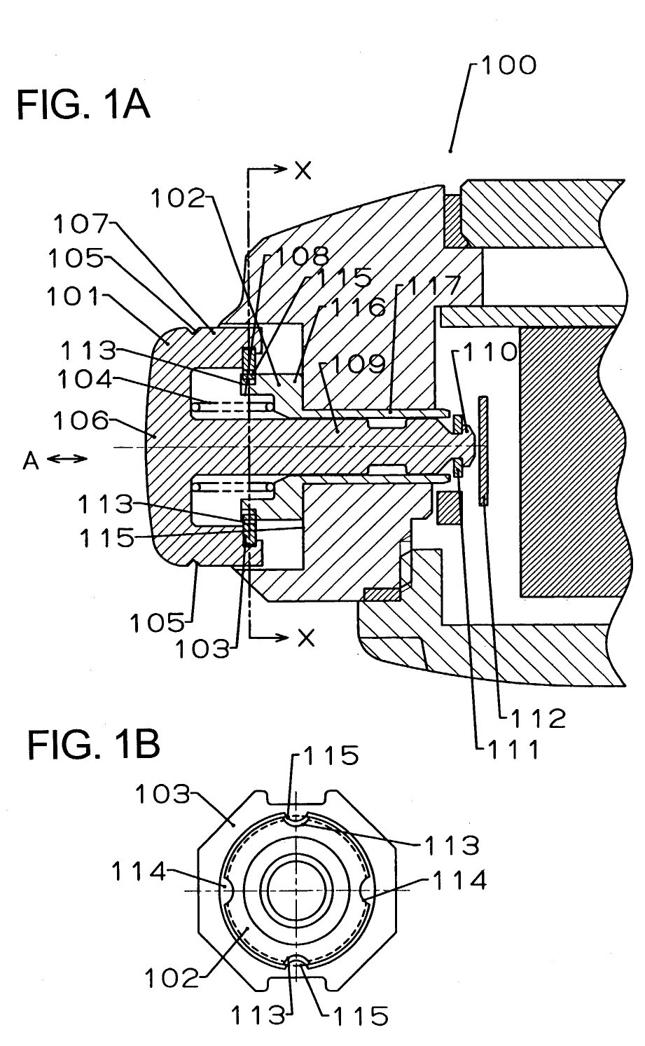

FIGS. 1 are views showing an operating part locking structure in a portable timepiece according to a first embodiment of the invention with an operating button 101 in a locked state. In addition, FIG. 1A is a front, cross sectional view and Fig. 1B is a partial, cross sectional view taken along a X-X direction in FIG. 1A.

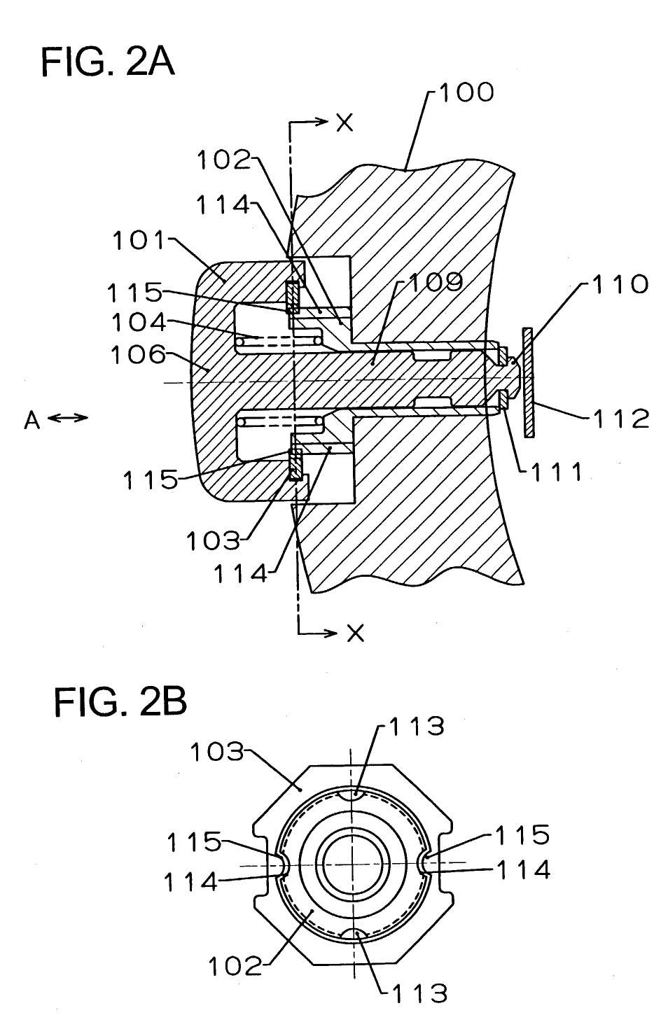

FIGS. 2 are views showing the operating part locking structure in the portable timepiece according to the first embodiment of the invention with the operating button 101 in an unlocked state (a state, in which the locked state is released. In addition, FIG. 2A is a front, cross sectional view and FIG. 2B is a partial, cross sectional view taken along a X-X direction in FIG. 2A.

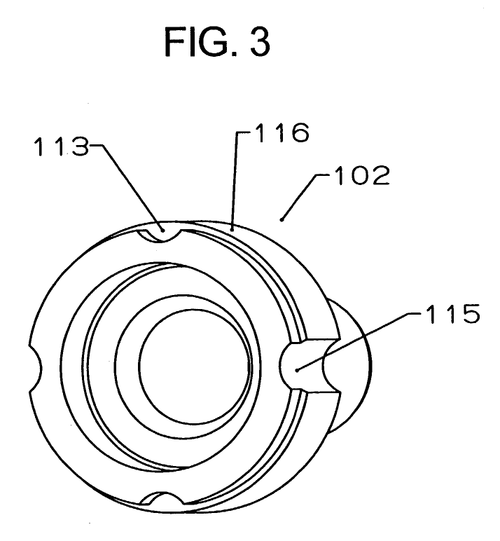

FIG. 3 is a perspective view showing a cylindrical member 102.

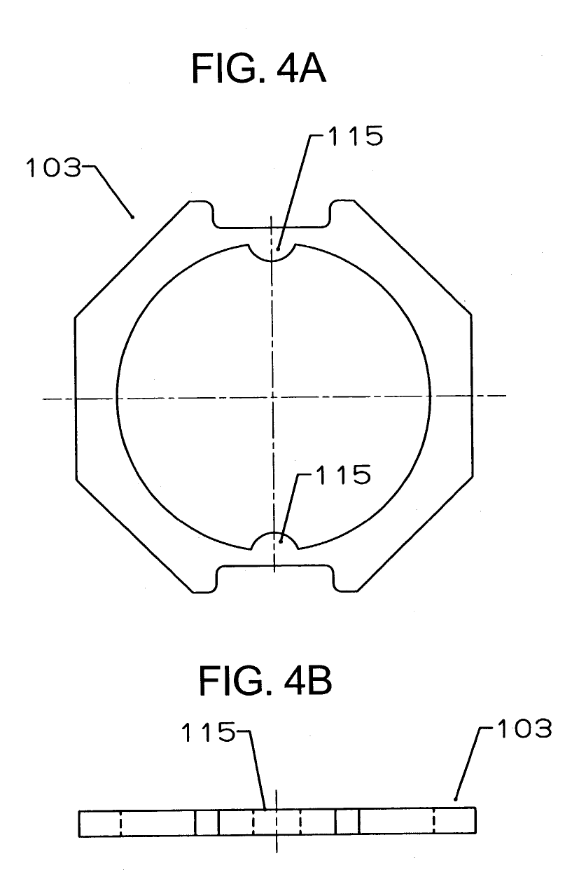

FIGS. 4 are views showing a stopper member 103, FIG. 4A being a front view, and FIG. 4B being a bottom view.

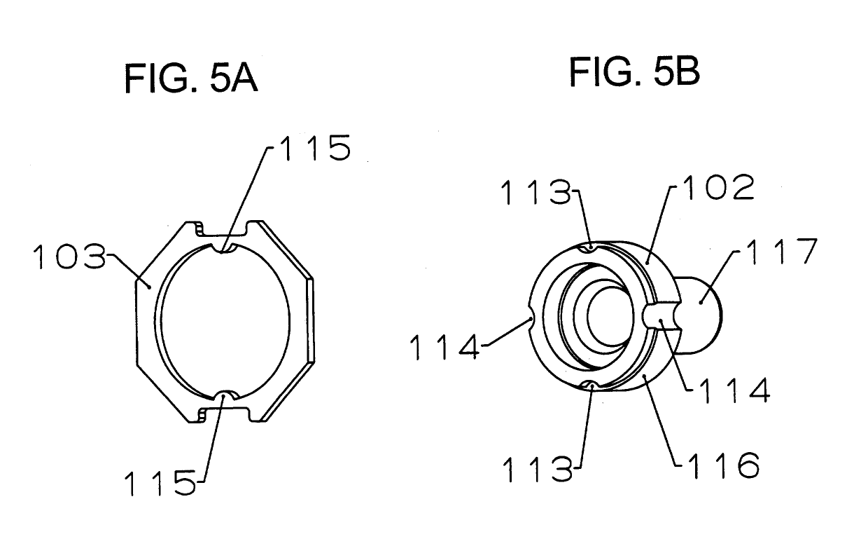

FIGS. 5 are exploded, perspective views showing portions of the operating part locking structure with the operating button 101 in the locked state.

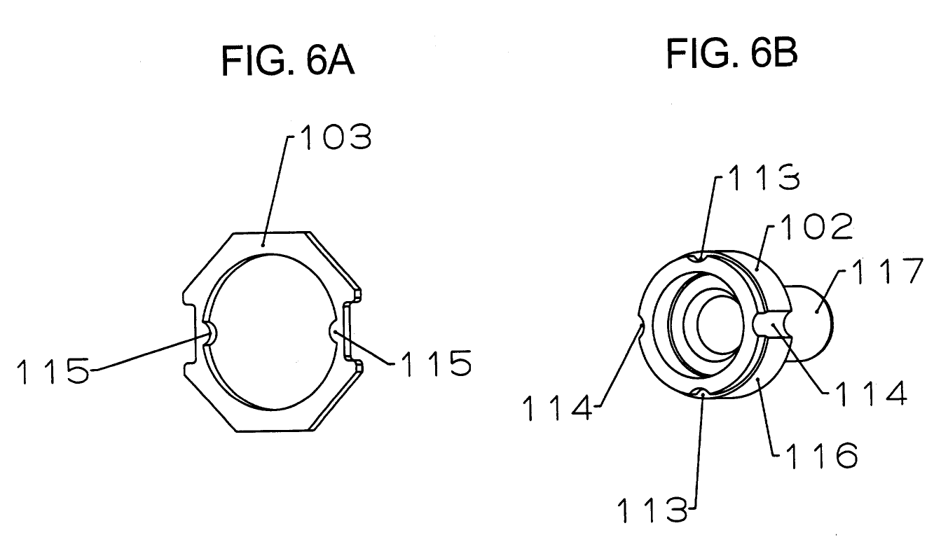

FIGS. 6 are exploded, perspective views showing portions of the operating part locking structure with the operating button 101 in the unlocked state.

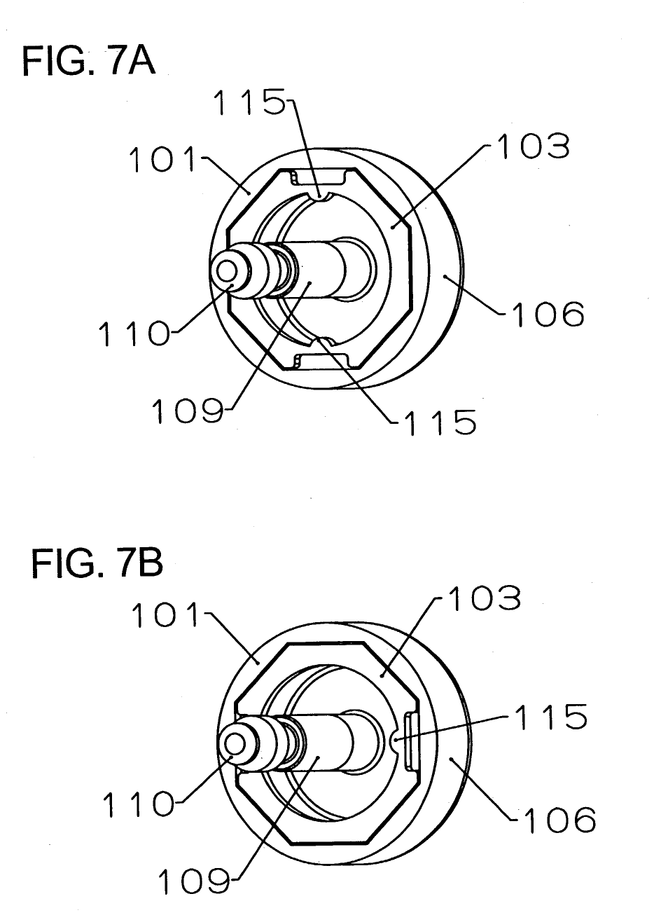

FIGS. 7 are exploded, perspective views showing portions of the operating part locking structure, FIG. 7A being a view showing the operating button 101 in the locked state, and FIG. 7B being a view showing the operating button 101 in the unlocked state.

In addition, in FIGS. 1 to 7, the same reference numerals denote the same parts.

In FIGS. 1 to 7, the operating part locking structure according to the embodiment of the invention comprises the operating button 101, the cylindrical member 102, the stopper member 103, a coil spring 104, and a pair of identification marks 105 composed of recesses and arranged in opposition to the operating button 101, the locking structure being provided integral with a casing 100 of a wrist timepiece body. The operating button 101 comprises a columnar-shaped head 106, and a columnar-shaped barrel 109 having a smaller diameter than that of the head 106. Formed on a side of the barrel 109 of the head 106 is a circular-shaped projection 107 along the circumference of an end of the head 106. A latch member 111 is provided integrally on an end 110 of the barrel 109 of the operating button 101.

The cylindrical member 102 comprises a large-diameter portion 116 and a small-diameter portion 117 having a smaller diameter than that of the large-diameter portion 116. The operating button 101 is received in the large-diameter portion 116 with a part of the head 106 protruding and the barrel 109 received in the small-diameter portion 117, and the operating button 101 is held slidably along an axial direction A of the barrel 109.

The coil spring 104 arranged between the operating button 106 and the cylindrical member 102 biases the operating button 101 in a direction (a direction in opposition to the casing 100), in which the button protrudes from the cylindrical member 102. The latch member 111 abuts against the small-diameter portion 116 of the cylindrical member 102 whereby the operating button 101 is prevented from falling off the cylindrical member 102 due to the bias of the coil spring 104.

Arranged in the circular-shaped projection 107 of the operating button 101 is the stopper member 103 integral with the operating button 101. The stopper member 103 is formed from an elastic material to be in the form of an annular-shaped (substantially octagonal shape in the embodiment). The stopper member 103 is formed with a pair of projections 115, 115 to protrude inwardly of the stopper member 103. Also, the projections 115, 115 are provided in pair in positions facing each other diametrically of the stopper member 103. The stopper member 103 rotates and slides together with the operating button 101 in accordance with rotation and sliding of the operating button 101.

Provided on an outer periphery of the operating button 101 are the identification marks 105, 105 indicative of a locked state and an unlocked state.

The large-diameter portion 116 of the cylindrical member 102 is formed at an outer periphery thereof with first grooves 113, 113 and second grooves 114, 114. The respective first grooves 113, 113 are formed along an axial direction of the cylindrical member 102 to have a predetermined depth, and the respective second grooves 114, 114 are formed along the axial direction of the cylindrical member 102 to have a predetermined depth larger than that of the first grooves 113, 113. Also, the first grooves 113, 113 and the second grooves 114, 114, respectively, are provided in pair in positions facing each other diametrically of the cylindrical member 102.

The constitution is in such a relationship that the respective grooves 113, 113 engage with the respective projections 115, 115 in a locked position while the respective grooves 114, 114 engage with the respective projections 115, 115 in an unlocked position.

In addition, while the grooves 114, 114 are formed to extend axially throughout the large-diameter portion 116 in the embodiment, they may have a depth, with which a stroke required for operation of the operating button 101 is ensured.

A switch 112 constituting a part being operated is arranged in the vicinity of the end 110 within the casing 100 such that the switch 112 can be operated in the unlocked state by operatively pushing the operating button 101 toward the casing 100.

An explanation will be given to a motion of the operating part locking structure constructed in the above manner.

First, when in the locked state, the respective constituent elements are in a state shown in FIGS. 1, 5 and 7A.

That is, the operating button 101 is put in a state with the identification marks 105, 105 positioned vertically.

In this state, the projections 115, 115 on the stopper member 103 are positioned to engage with the grooves 113, 113 of the cylindrical member 102, respectively. Engagement of the projections 115, 115 with the grooves 113, 113 disables the pushing operation even when it is tried to operatively push the operating button 101 toward the casing 100.

In addition, a user can readily know the locked state because the identification marks 105, 105 are positioned vertically of the operating button 101.

The operating button 101 is put in an unlocked state by rotating the operating button 90 degrees leftward or rightward from this state.

In the course of shifting from the locked state to the unlocked state, as the operating button 101 is rotated, the stopper member 103 rotates together with the operating button 101. At this time, since the stopper member 103 is composed of an elastic member, the projections 115, 115 rotate while being deformed in a manner to get over an outer peripheral surface of the cylindrical member 102, and the respective projections 115, 115 shift to the unlocked position, in which they engage with the grooves 114, 114, from the locked position, in which they engage with the grooves 113, 113.

In the unlocked state, the respective constituent elements are in a state shown in FIGS. 2, 6 and 7B.

In addition, the projections 115, 115 engage with the grooves 114, 114, whereby a click feeling is obtained in the rotating operation of the operating button 101 and so switchover to the unlocked state from the locked state can be known by an operating feeling of the operating button 101.

In a state, in which the projections 115, 115 engage with the grooves 114, 114, the operating button 101 can be operatively pushed toward the casing 100.

Also, since the identification marks 105, 105 on the rotating member 102 are positioned right and left, a user can know that the unlocked state is present.

In the unlocked state, the switch 112 is operated by operatively pushing the operating button 101 toward the casing 100. Thereby, the function corresponding to the switch 112 can be implemented.

When the unlocked state should shift to the locked state, shifting to the locked state is effected by rotating the operating button 101 by 90 degrees leftward or rightward. In addition, since the projections 115, 115 shift to a position, in which they engage with the grooves 113, 113, from a position, in which they engage with the grooves 114, 114 also at this time, a click feeling is obtained in the rotating operation of the operating button 101 and so switchover to the locked state from the unlocked state can be known by an operating feeling of the operating button 101.

In this manner, switchover between the locked state, in which the operating button 101 is locked, and the unlocked state, in which the operating button 101 is released from the locked state, is made possible.

As described above, an operating part locking structure in a portable timepiece including a timepiece body with a clocking part received in a casing 100, apart 112 being operated and received in the casing 100, and an operating part 101 exposed outside the casing 101 and for operating the part 112 being operated comprises a cylindrical member 102 provided integrally on the casing 100 and having first grooves 113, 113 having a predetermined depth and second grooves 114, 114 having a depth larger than the first grooves 113, 113, which grooves are formed in an axial direction of the cylindrical member, an operating part 101 arranged to be able to be rotatingly operated between a locked position and an unlocked position and to operatively push the cylindrical member 102 in the unlocked position toward the casing 100, and a stopper member 103 provided integrally on the operating part 101 and having projections 115, 115, and the projections 115, 115 of the stopper member 103 when being in the locked position engage with the first grooves 113, 113 to prevent the pushing operation of the operating part 101 and when being in the unlocked position engage with the second grooves 114, 114 to permit the pushing operation of the operating part 101.

Accordingly, the rotating member can instantaneously make switchover of the operating part between the locked state and the unlocked state.

Also, when making switchover between the locked state and the unlocked state, it suffices to rotate the operating part 101 a predetermined angle (90 degrees in the above embodiment), and it is unnecessary to rotate the operating part 101 plural times, so that switchover between the locked state and the unlocked state can be instantaneously made.

Also, since the identification marks are provided on the operating part 101, it is possible to readily recognize whether the operating part 101 is in the locked state or the unlocked state.

Also, there is produced an effect that the possibility of failure is less even when the operating part 101 is rotated to excessive degrees, because the operating part 101 is formed to be rotatable relative to the cylindrical member 102 and its simple rotation results in switchover between the locked state and the unlocked state.

In addition, while the stopper member 103 in the above embodiment is formed to be substantially octagonal in shape, it may be formed to be annular such as circular or the like in shape, and can afford various modifications such as arcuate or the like in shape.

Also, while the projections 115, 115 and the grooves 113, 113 are provide in plural, each of them may be one.

According to the invention, when making switchover between the locked state and the unlocked state, it is unnecessary to rotate the operating part plural times, so that switchover between the locked state and the unlocked state can be instantaneously made.

Also, it is possible to readily recognize whether the operating part is in the locked state or the unlocked state.

Also, there is produced an effect that the possibility of failure is less even when the operating part is rotated to excessive degrees.

What is claimed is:

1. A portable timepiece comprising:
a timepiece body with a clocking part received in a casing;
a part being operated and received in the casing;
an operating part exposed outside the casing and for operating the part being operated;
a cylindrical member provided integrally on the casing and having a first groove with a predetermined depth and a second groove with a depth larger than the first groove, which the grooves are formed in an axial direction of the cylindrical member;
an operating part arranged to be able to be rotatingly operated between a locked position and an unlocked position and to operatively push the cylindrical member in the unlocked position toward the casing; and
a stopper member provided integrally on the operating part and having a projection; and wherein the projection of the stopper member when being in the locked position engage with the first groove to prevent the pushing operation of the operating part and when being in the unlocked position engage with the second groove to permit the pushing operation of the operating part.

2. A portable timepiece according to claim 1, wherein the stopper member is formed from an annular-shaped member and the projection is formed to protrude inwardly of the annular-shaped member.

3. A portable timepiece according to claim 2, wherein the annular-shaped member is elastic.

4. A portable timepiece according to claim 2, wherein the first groove and the second groove, respectively, are provided in pair in positions facing each other diametrically of the cylindrical member, and the projection is provided in pair in positions facing each other diametrically of the annular-shaped member.

5. A portable timepiece according to claim 1, wherein the operating part is provided with identification marks, which are indicative of a locked state and an unlocked state.

6. A portable timepiece according to claim 1, wherein the part being operated is a switch.
